(19) United States
(12) Patent Application Publication
(10) Pub. No.: US 2002/0052237 A1
(43) Pub. Date: May 2, 2002

(54) Operating device with pendulum joystick

(76) Inventor: Christopher L. Magill, Snohomish, WA (US)

Correspondence Address: NIXON & VANDERHYE P.C., 8th Floor, 1100 North Glebe Rd., Arlington, VA, 22201-4714, US

(21) Appl. No.: 09/800,518

(22) Filed: Mar. 8, 2001

Related U.S. Application Data
(60) Provisional application No. 60/219,698, filed on Jul. 21, 2000.

(51) Int. Cl. A63F 13/00

(52) U.S. Cl. 463/38

(57) ABSTRACT

An analog joystick for a game machine controller is provided that is disposed as a pendulum that depends downwardly from the operating device housing so that inclination of the housing from its prescribed home orientation effects the contact conventionally afforded by digital manipulation. In a preferred embodiment, a length of the joystick and/or a weighted portion of the joystick can be adjusted or replaced so as to alter an inclination sensitivity of the operating device.

This application claims the benefit of U.S. Provisional Application No. 60/219,698, which was filed Jul. 21, 2000. The disclosure of which is incorporated herein by this reference.

### BACKGROUND AND SUMMARY OF THE INVENTION

The present invention relates generally to a device including a control lever or joystick wherein the device converts at least one position of the joystick into electric information that is in turn used to control the displacement of a reference point or character on a monitor. More specifically, the present invention relates to an operating device having a pendulum analog joystick and that is, in use, connected to an image processor for generating image data of an image to be displayed on a monitor and outputs operation signals that can modify the image data according to an operation by an operator of the operating device.

An operating device having an analog joystick connected to an image processor that generates image data of an image to be displayed on a monitor such as a television, receiver or the like and outputs operation signals that can modify the image data, i.e., the image, according to an operation by an operator is the subject of U.S. Patent No. 5,984,785, the entire disclosure of which is incorporated herein by this reference. The operating device or controller of the '785 patent includes a hand holdable housing and an analog joystick provided to project upwardly from the housing. The analog joystick includes a lever having a tip end that protrudes from a hole in the upper surface of the housing and can be inclined relative to its home, vertical position with one or more of the operators digits, generally the thumb, thereby to actuate the joy stick and control the on screen image. This device has been favorably received by computer game enthusiasts. However, some potential operators of video games may, due to injury, disease, or other malady, have limited manual dexterity such that, due to the absence of or limited control of one or more fingers, they may not be able to effectively operate the analog joystick of a controller of the type described in the '785 patent. Other video game operators may have mastered the use of an analog joystick of the type disclosed in the '785 patent and, therefore, have an interest in a different type of video game control.

It would therefore be desirable to provide an operating device or controller for a video game of the type disclosed in the '785 patent, but which is adapted to control or modify the image data according to an inclination of the operating device such as by wrist flexion or forearm inclination rather than by finger manipulation.

Accordingly, it is an object of the invention to provide an analog joystick for a game machine controller wherein the analog joystick is disposed as a pendulum that depends downwardly from the operating device housing so that inclination of the housing from its prescribed home orientation effects the contact conventionally afforded by digital manipulation. The term analog joystick as used herein refers generally to the provision of a lever and associated control mechanism that can output a directional control signal determined by a direction in which the lever is inclined. Thus, more specifically, it is an object of the present invention to provide an operating device with a pendulum analog joystick that is capable of continuously and securely outputting the direction signal even if it is desired that a designated direction be finely changed.

It is a further object of the invention to provide an analog pendulum joystick wherein a length of the joystick and/or a weighted portion of the joystick can be adjusted or replaced so as to alter an inclination sensitivity of the operating device. An adjustable pendulum joystick as aforesaid has the advantage that it can be adjusted according to the individual's dexterity and can be modified as the individual becomes accustomed to and improves his or her pendulum control technique.

### BRIEF DESCRIPTION OF THE DRAWINGS

These, as well as other objects and advantages of this invention, will be more completely understood and appreciated by careful study of the following more detailed description of the presently preferred exemplary embodiments of the invention taken in conjunction with the accompanying drawings, in which:

FIG. 1 is a perspective view showing one embodiment according to the present invention;

FIG. 2 is a side elevational view of the embodiment of FIG. 1, partly broken away to illustrate the pendulum joystick of the invention;

FIG. 3 is a perspective view showing an analog pendulum joystick unit that is capable of being utilized in the first embodiment of the invention;

FIG. 4 is a perspective view showing a major portion of the joystick unit of FIG. 3;

FIG. 5 is an exploded perspective view showing a major portion of the joystick unit of FIG. 3;

FIGS. 6A and B are illustrative cross-sectional views showing a major portion of the joystick unit of FIG. 3;

FIG. 7 is an illustrative view showing a guided state of a lever by a guide ring; and

FIG. 8 is an elevational view of a weighted pendulum joystick illustrating a detachable joystick part and weight adjustment alternative according to an embodiment of the invention.

### DETAILED DESCRIPTION OF THE PRESENTLY PREFERRED EXEMPLARY EMBODIMENTS

It will be understood that to provide a pendulum analog joystick embodying the invention, the analog joystick unit as disclosed in the '785 patent can be essentially repositioned in the operating device housing so that the unit is disposed adjacent a lower wall of the housing for the joystick to protrude downwardly therefrom, and a suitably weighted and extended joystick arm provided to extend therefrom. As will be appreciated, when physically relocating the joystick unit in this manner, if the forward/north position and rearward/south position with respect to the operator are maintained as disclosed in the '785 patent, those control guide wall portions of the joystick unit that would have been disposed on the left of the upper housing will now be disposed on the right side of the bottom portion of the housing and the control guide wall portions that would have been disposed on the right side of the upper surface of the housing will now be disposed on the left side. Accordingly, with such a physical repositioning, the control will be the mirror image of that provided when the joystick unit was on the upper surface of the housing. This means that as the operating device is manually tilted to the right, it will cause the image or character control to move to the left and vice versa. Such a ‘mirror image’ control may be challenging and fun in some cases, but in general it would be preferable for the inclination of the operating device to be translated to a corresponding image or character movement on the video screen. To accomplish this, the hard wiring of the joystick unit can be readily modified to accommodate the reversal in control directions, so that tilting to the right will result in character or image movement to the right, etc. As an alternative to modifying the joystick unit to reflect the new directional control, the software of the image processor can be suitably modified to appropriately interpret the joystick unit signals.

Although the image control provided by the joystick unit of the '785 patent will typically be modified to accommodate the bottom orientation thereof in accordance with the invention, as noted above, structurally, the joystick unit of the invention preferably generally corresponds to that of the '785 patent, with exceptions as noted below. Therefore, for ease of description, reference numbers corresponding to those used in the '785 patent, but incremented by two hundred, are used herein to identify the generally corresponding parts of the operating device and joystick unit of the invention.

In the following, an embodiment in which an operating device with pendulum analog joystick according to the present invention is applied to a video game machine that displays a game character on a screen of a monitor in accordance with a game program stored in a memory device (semiconductor memory, CD-ROM, etc.) and controls the game character will be described. However, it is pointed-out in advance that the operating device according to the present invention can be, while in use, connected to a multipurpose image processor that generates image data of an image to be displayed on the monitor in accordance with a program. In such a case, the operating device outputs an operation signal that can modify the image data generated by the image processor, i.e. the image on the monitor, in accordance with an operation by an operator.

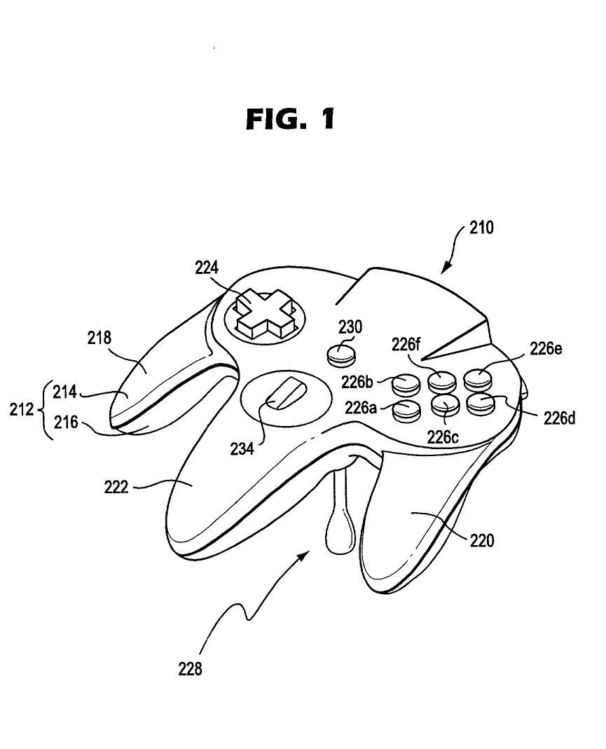

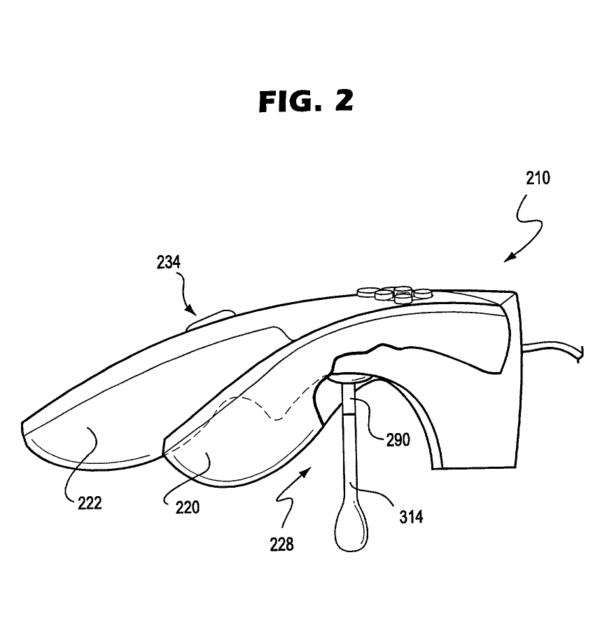

With reference FIGS. 1 and 2, an operating device 210 according to an embodiment of the invention includes a housing 212 having an upper half 214 and a lower half 216. At both left and right ends of the housing 212, a left grip 218 and a right grip 220 are respectively formed in a manner that the same are protruded toward a proximal, operator side. At an intermediate position between the left grip 218 and the right grip 220, a center grip 222 is formed to also protrude toward the operator side. A cross-direction designation switch 224 which is a digital joystick is formed on the upper surface of the housing 212 in the vicinity of a base end of the left grip 218. Action designation switches 226a, 226b, 226c, 226d, 226e and 226f, which in this example designate six (6) kinds of actions, are respectively formed on the upper surface of the housing 212 in the vicinity of a base end of the right grip 220. An upper surface switch or trigger 234 is also formed, in this embodiment, on the housing 212 in the vicinity of a base end of the center grip 222. At an approximately central position of the housing 212, a start switch 230 which designates a start of a game is formed. Furthermore, the start switch 230 is positioned at an approximately center of an area surrounded by the switches 224 and 226a to 226f, and the upper surface switch 234.

Grips 218, 220 and 222 are respectively formed as protruded portions that are respectively generally uniformly formed on the upper half 214 and the lower half 216, and therefore, in the following, it is to be noted that references to “housing” indicate the entirety of the housing 212, including the grips 218, 220 and 222.

Furthermore, a pair of side surface switches (only one of which can be seen in FIG. 1) are formed on a rear surface of the housing 212, and a pendulum, analog joystick 228 which is capable of designating all directions within 360 degrees is formed at an approximate center of the lower half 216 in the vicinity of the base end of the center grip 222.

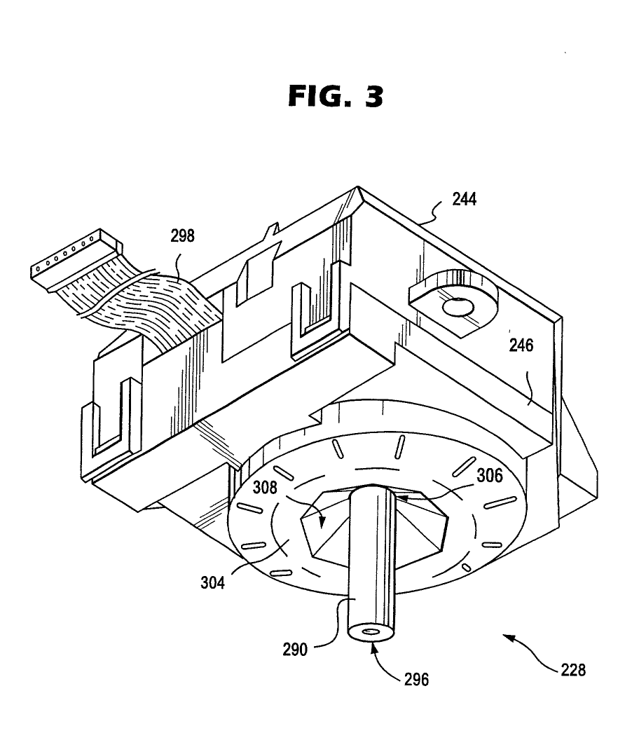

Now, with reference to FIG. 3 to FIG. 7, the pendulum analog joystick 228 will be described in detail. As presently proposed, the analog joystick 228 is constructed as a joystick unit, as shown in FIG. 3. The joystick unit is sandwiched between the upper half 214 and the lower half 216. The joystick unit includes a housing formed by a case 244 and a bottom cover 246, and an inner case 248 is accommodated within the housing.

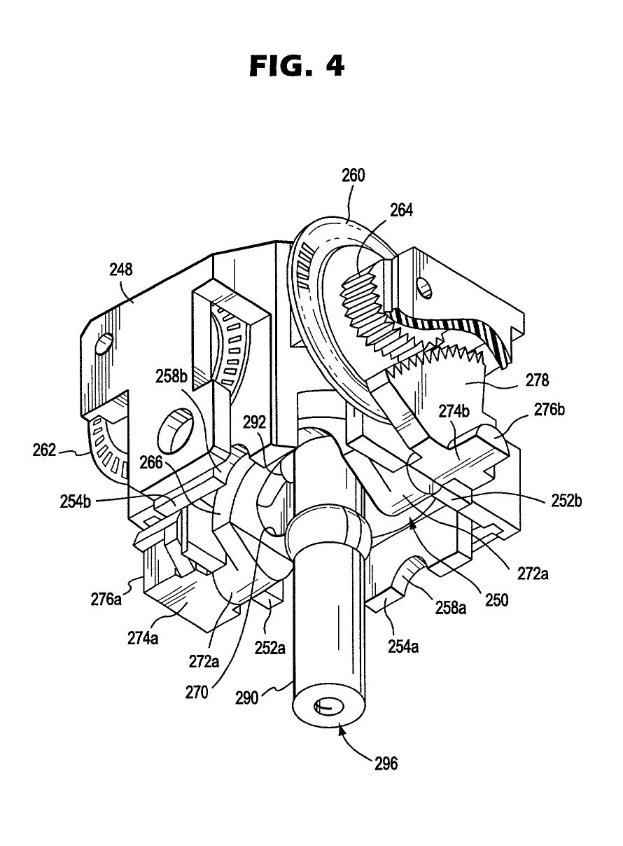

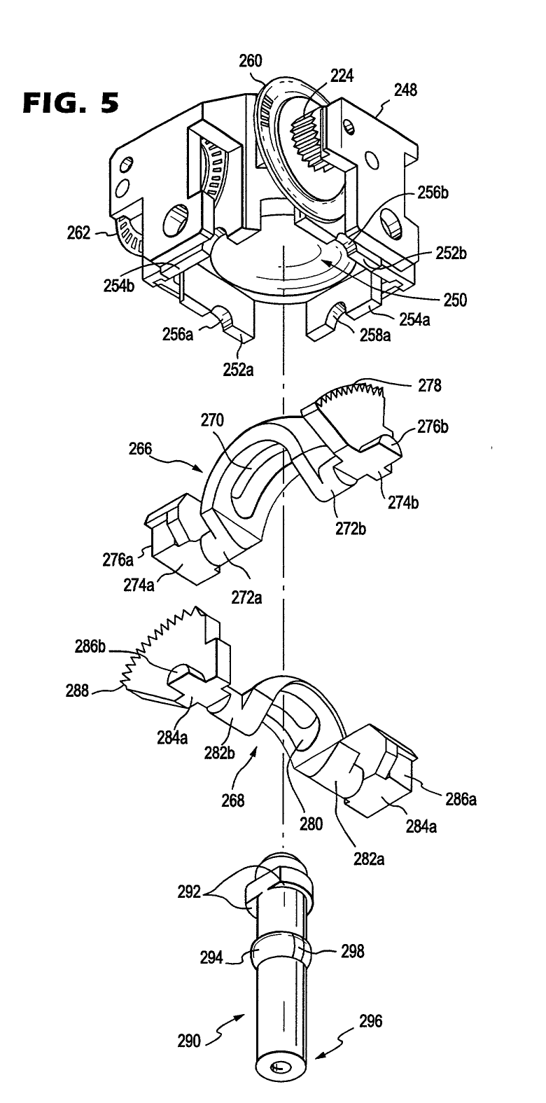

As shown in FIG. 4 and FIG. 5, the inner case 248 includes a bowl-shaped recess portion 250 formed at a center of the inner case 248, and two pairs of support plates 252a, 252b and 254a, 254b around the recess portion 250 with angle-interval of 90 degrees. Semicircular bearings 256a, 256b and 258a, 258b are formed on the support plates 252a, 252b and 254a, 254b, respectively. The bearings 256a, 256b or 258a, 258b are arranged on the same axis line, and axes of the bearings 256a, 256b and 258a, 258b are at the same height level, and orthogonally intersect each other. Slit wheels 260 and 262 having rotation shafts which orthogonally intersect each other are rotatably supported at a side surface of the inner case 248, and gears 264 are uniformly formed on the respective slit wheels 260 and 262.

The analog joystick unit further includes swingable members 266 and 268. One swingable member 266 is formed by an arc-like member which is provided with a long hole being made long in a longitudinal direction of the arc-like member, and supporting shafts 272a and 272b are formed at both arc-like member, and supporting shafts 272a and 272b are formed at both ends of the swingable member 266, and shaft end portions 276a and 276b respectively having flat surfaces 274a and 274b are extended from the supporting shafts 272a and 272b, and a sector gear 278 is provided on one one swingable member 266 in that the swingable member 268 is constructed by an arc-like member having a radius of curvature smaller than that of the swingable member 266; however, in other respects, the swingable member swingable member 266; however, in other respects, the swingable member member 266. That is, reference numeral 280 denotes a long hole, reference numerals 282a and 282b denote supporting shafts, reference numerals 284a numerals 282a and 282b denote supporting shafts, reference numerals 284a and 284b denote flat surfaces, reference numerals 286a and 286b denote

The supporting shafts 272a, 272b and 282a, 282b are individually

The supporting shafts 272a, 272b and 282a, 282b are individually case 248 and, therefore, the pair of swingable members 266 and 268 can be supported in a free swinging fashion, and the swingable members 266 and 268 are arranged in a state where longitudinal directions of the long holes 270 and 280 orthogonally intersect each other and are overlaid with an interval or gap. With the pair of swingable members 266 and 268 thus attached to the inner case 248, the sector gears 278 and 280 bite the above described gears 264. Furthermore, respective ones of the above described flat surfaces 274a, 274b and 284a, 284b are included in the same horizontal plane in a neutral state of a lever portion 290 of joystick 228.

As shown in FIG. 5, the lever portion 290 includes protrusions 292 which are protruded toward outer radius directions at one end thereof, a ball portion 294 at a middle portion of the lever portion 290, and a connection portion 296 at the other, free end of the lever portion 290. Grooves 298 which are extended in a latitude direction at positions apart from each other by 180 degrees are formed on the above described ball portion 294. A diameter of the lever portion 290 is selected at a size which is not larger than the width of the long holes 270 and 280 formed in the swingable members 266 and 268. Preferably, the diameter of the lever portion 290 is a size by which the lever portion 290 can be slidably inserted into the long holes ched to the inner case 248 and, therefore, if the lever portion 290 is pulled-down, the engagement of the lower swingable member 268 with the ions 292 are fit into the long hole 270 of a upper side swingable member 266. Therefore, the protrusions 292 of the lever portion 290 protrude in a direction orthogonal to the longitudinal direction of the long hole 280 of a lower swingable member 268 attached to the inner case 248 and, therefore, if the lever portion 290 is pulled-down, the engagement of the lower swingable member 268 with the protrusions 292 prevents the lever portion 290 from being pulled out.

The assembly shown in FIG. 4 is accommodated within the outer case 244 shown in FIG. 3. At this time, the inner case 248 is fixed to the outer case 244 by a suitable means such as screws (not shown). In a state where the inner case 244 is thus attached to the outer case 244, light-emitting elements and light-receiving elements (not shown) arranged on the outer case 244 are opposite to the two slip wheels 260 and 262. In addition, the height level of swing-shafts (supporting shafts 272 and 282) of the swingable members 266 and 268 are coincident with a height level of a center of the ball portion 294. Furthermore, a printed-circuit board (not shown) to which a flexible wiring plate 298 is connected is assembled in the outer case 244, and the above described light-emitting elements and the light-receiving elements are electrically connected to printed patterns of the board.

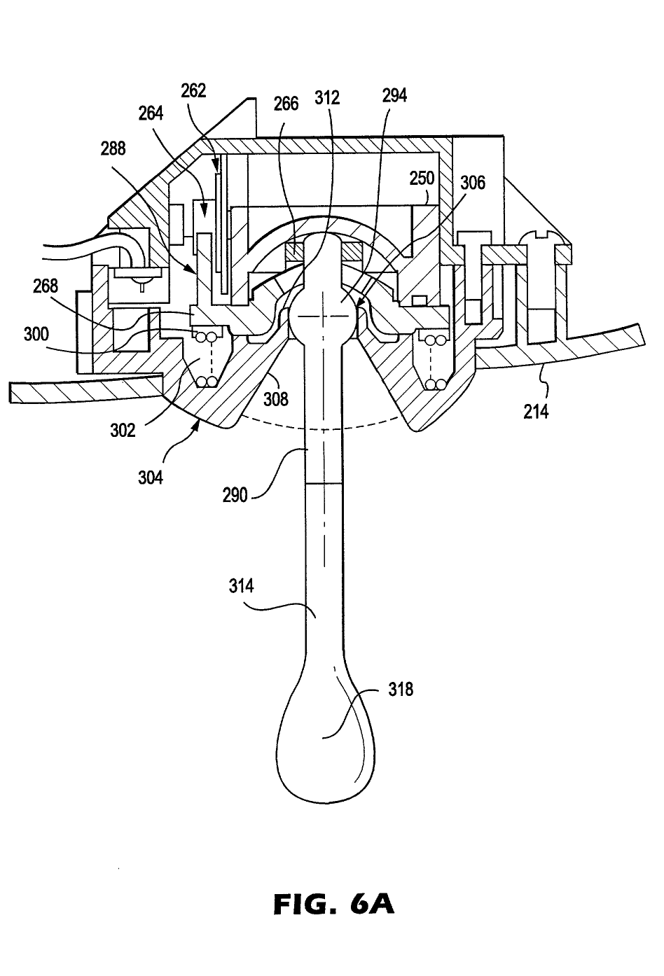

As shown in FIGS. 6A and B, a ring with groove 300 is supported above the flat surfaces 274 and 284 provided on the pair of swingable members 266 and 268, and a coil spring 302 is arranged above the ring with groove 300. The ring with groove 300 is one example of a pushing member, and in the neutral state of the lever portion 290, a lower surface of the ring 300 becomes horizontal, and the lower surface of the ring 300 and the above described flat surfaces 274 and 284 are brought into surface-contact with each other.

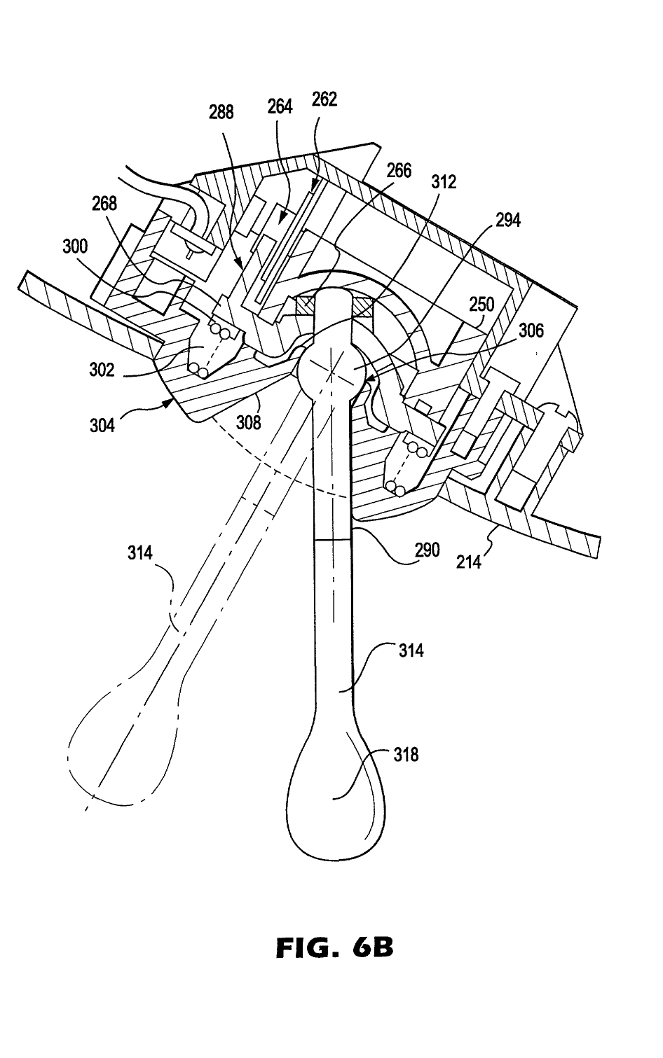

As shown in FIGS. 6A and B, a guide ring 304 is attached to the bottom cover 246, and a circular hole 306 is formed at a center portion of the guide ring 304. The guide ring 304 further includes a guide wall 308 which is a rising slope raised from an inner periphery defining the hole 306 toward an outer periphery of the guide ring 304. That is, the guide wall 308 is formed as a whole in an inverted “earthenware mortar” or “cone”-shape. Then, in viewing the guide wall 308 from below, the guide wall 308 has an outer edge 310 which becomes octagonal as shown in FIG. 7.

In addition, a diameter of the hole 306 is a size that is the same or approximately same as a diameter of an outer peripheral surface of the ball portion 294 of the above described lever portion 290. Therefore, as shown in FIG. 6A, the inner edge defining the hole 306 is brought into contact with the ball portion 294 of the lever portion 290 and, therefore, the lever portion 290 is supported by the ball portion 294 and the hole 306 so that the lever portion 290 can be swung or inclined in any direction. This is effectively achieved according to the invention by tilting the housing 212 relative to horizontal, although the joystick 228 can be displace manually. Circular bosses 312 are formed at two positions apart from each other by 180 degrees on the inner edge defining the hole 306 of the guide ring 304 so that the bosses 312 are protruded toward an inner radius direction of the hole 306, and the bosses 312 individually fit into the grooves 298 formed in the latitude direction of the above described ball portion 294. Therefore, there can be relative swinging between the lever portion 290 and an axis of the bosses 312, but the lever portion 290 can not be rotated around the axis of the lever portion 290 itself. Also, as mentioned above, the protrusions 292 of lever portion 290 are fit into the long hole 270 of a upper side swingable member 266, thereby preventing relative rotation. Therefore, the lever portion 290 is prevented from being rotated around its axis by the grooves 298 of the ball portion 294 and the bosses 312, and by the protrusions 292 fit into the long hole 270 of a upper side swingable member 266. Thus, the lever portion is also prevented from being rotated around its axis when the extension portion 314 of the pendulum joystick (discussed herein below) is attached or detached therefrom.

When the bottom cover 246 is attached to the case 244, the spring 302 is sandwiched and compressed between the ring with groove 300 and the cover 246. Therefore, the flat surfaces 274 and 284 of the pair of swingable members 266 and 268 are always depressed by a force of the spring 302 via the ring with groove 300, and by such a depressing operation, the pair of swingable members 266 and 268 are always elastically biased so as to become an attitude that both members 266 and 268 are not inclined in any direction, and therefore, the lever portion 290 is oriented to a downwardly vertical attitude, that is, the lever portion 290 is always elastically biased into the neutral state thereof.

In the above described pendulum analog joystick unit, according to an inclined direction and an inclined angle of the housing 212 while the lever portion 290 remains perpendicular to horizontal due to the weighted tip 318 thereof, the swingable members 266 and/or 268 are swung (just as if the joystick was inclined and the housing maintained in position) and then, the slit wheels 260 and/or 262 are rotated in accordance with the inclined angle of the swingable members 266 and/or 268, and therefore, pulses according to rotation amounts of the slit wheels 260 and/or 262 are outputted, and the pulses are utilized as coordinate signals in X axis and/or Y axis directions.

Now, the guide ring 304 will be described in detail. As described above, the guide ring 304 includes the guide wall 308 having the octagonal outer edge 310 in viewing the guide ring 300 from below. Respective corners of the octagonal outer edge 310 function as recess portions which receive the lever portion 290 as shown in FIG. 7. Therefore, in this embodiment shown, the respective corners are positioned at eight positions with intervals of 45 degrees of upper (North), lower (South), left (West), right (East), a center position between upper and left (North-West), a center position between upper and right (North-East), a center position between lower and left (South-West) and a center position between lower and right (South-East). As to a point N indicative of upper (North) shown in FIG. 7, guide walls 308a and 308b which sandwich the point N are converged at point N. That is, both guide walls 308a and 308b intersect each other, and the position that they intersect is point N. Therefore, if the housing 212 is inclined so that point N approaches lever portion 290, the lever portion 290 is guided relative to the housing 212 by the guide walls 308a and 308b, and finally, positioned at the point N. Therefore, at a time that the movable character (not shown) on the monitor (not shown) is intended to be moved upward, for example, that is, at a time that the movable character is to be moved in a straight-going direction of the movable character, the housing is inclined so that point N approaches lever portion 290, as shown in FIG. 6B. That is, when the movable character is to be advanced straight, the housing 212 is inclined so that the lever portion 290 is in a vicinity of the point N, and the lever portion 290 will be guided to the point N along with the guide walls 308a and 308b adjacent to the point N, and therefore, only by holding such a state, it is possible to surely advance the movable character straight.

Furthermore, a sloped angle of the guide wall 308 of the guide ring 304 is determined in a manner that the lever portion 290 is parallel to guide wall 308 when the housing is maximally inclined, as shown in FIG. 6B. That is, in a state where the housing is maximally inclined to lever portion 290 in any direction, the lever portion 290 is brought into contact with the guide wall 308 in parallel therewith. Therefore, the guide wall 308 also has the function of a lever guide as well as the role of a lever stopper.

To facilitate packaging, so that the downwardly depending pendulum joystick does not obstruct storage of the operating device by the operator or packaging of the controller with a video game unit or console, the pendulum joystick 228 is advantageously formed in at least two parts. More specifically, lever portion 290 of the joystick unit is preferably provided with a pendulum extension 314 which is attached to the lever portion 290 via the connection portion 296. In this manner, the elongated, weighted, extension portion 314 of the pendulum can be detached with respect to the lever portion 290 for packaging and storage. To minimize the risk of loss of the components, an internal tether (not shown) may be provided so that when the two joystick parts are mechanically disengaged, the tether maintains the two components 290, 314 at a prescribed maximum separation and the tether is flexible to allow the detached pendulum extension portion 314 to be, e.g., laid flat relative to the control device 210. In the alternative, the two pendulum parts can simply be detached and the detached extension portion 314 suitably stored, for example, with game cartridges and the like for future use.

As will be appreciated, the weight of the tip 318 of the extension portion 314 of the pendulum 228, and the length of the pendulum 228 as well as the strength of the return spring 302 will all determine the operator's ability to effectively manipulate the operating device to control the image or character controlled by the joystick. In one example, a five inch pendulum joystick 228 having a weighted tip of about 2 to 3 ounces has been found to effectively counter the force of the spring 302 so that manually inclining the operating device housing 212 relative to the pendulum joystick 228 allows the on-screen image or character to be directionally controlled. As an alternative, the spring tension of the joystick unit spring 302 can be adjusted and/or the length of the pendulum 228 and/or the weight thereof can be adjusted accordingly. Thus, in an exemplary embodiment, the downwardly depending extension portion 314 of the pendulum joystick 228 can be removed and replaced as desired with a heavier or lighter; longer or shorter portion so as to adjust the sensitivity and ease of control of the device. As noted above, the removable extension portion 314 of the pendulum 228 also has the advantage of facilitating packaging and storage.

As a further alternative to provide for control adjustment, a weight 418 can be provided that is selectively displaceable, e.g. by rotating a washer 419 supporting the same and threadably engaged with a lower, detachable pendulum portion 414. In this manner, the desired control adjustment can be effected by the end user by appropriately locating the weight 418, and/or replacing the weight with a lesser or greater weight, to accommodate their increasing skill and/or to accommodate the different skills of a number of users of a single controller.

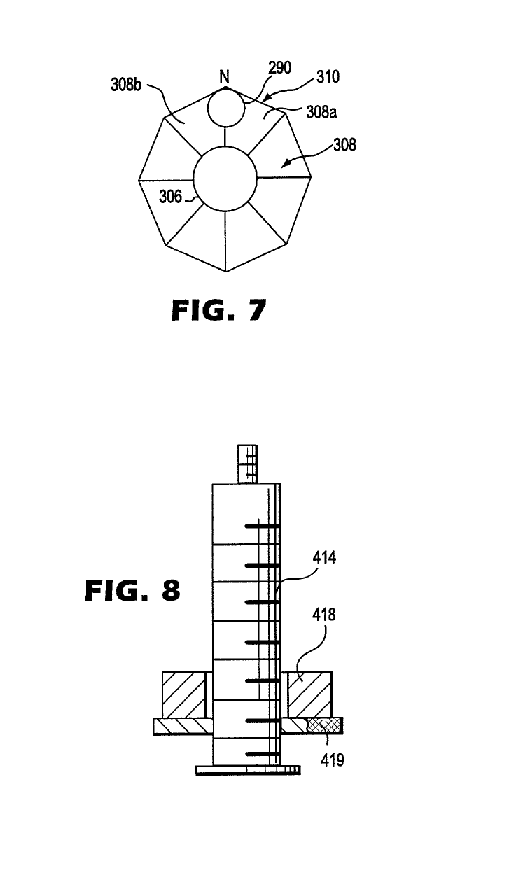

In the illustrated embodiment, the connector portion 296 is a threaded bore. Accordingly, a threaded tip, shown at 417 in the FIG. 8 embodiment, is provided to detachably engage with the lever portion 290. It is to be understood, however, that other known connection mechanisms for connecting components end to end, including a frictional coupling, a snap lock coupling, a bayonet coupling and the like may be provided to detachably engage the extension portion 314, 414 to the lever portion 290.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. Thus, while the invention has been described above with reference to control of a character on screen, it is to be understood that the operating device having a pendulum joystick may also be used for a marble and maze type game requiring balance to navigate the cursor or ball through a maze. The pendulum joystick may also be used in a game requiring a steady hand, such as a video version of a game such as OPERATION.

What is claimed is:

1. A game machine controller for use with a game machine that displays an image on a monitor, for controlling the image, the game machine controller comprising:
a housing having an upper surface and a bottom surface and at least one portion formed to be grasped by the operator;
a first operating device including a control element, said first operating device being mounted to said housing so that said control element depends downwardly to project from the bottom surface of said housing, said first operating device being constructed and arranged for relative pivotal movement between said housing and said control element and said control element having a length and being weighted such that, when said housing is inclined to horizontal, said control element remains generally perpendicular to horizontal, whereby inclination of the housing inclines the housing relative to the control element,
said first operating device being operable for use as a first moving direction designation input device that designates at least a moving direction of an image or game character according to a inclination of the housing relative to the control element.

2. A game machine controller as in claim 1, wherein said first operating device is constructed and arranged and mounted to said housing such that relative pivotal movement between said housing and said control element through about 360°is possible

3. A game machine controller as in claim 1, wherein said portion formed to be grasped by the hand of the operator comprises a protruded portion protruding rearwardly from said housing.

4. A game machine controller as in claim 1, further comprising an annular control element stop for limiting a relative inclination of said housing and said control element.

5. A game machine controller as in claim 1, wherein said control element is comprised of at least two portions, a first, lever portion of said control element being mounted to and projecting from said housing and a second, extension portion coupled to a free end of said lever portion.

6. A game machine controller as in claim 5, wherein said extension portion is detachably coupled to said lever portion.

7. A game machine controller as in claim 6, wherein said detachable coupling comprises a threaded coupling.

8. A game machine controller as in claim 5, wherein said extension portion includes a weighted portion for maintaining a vertical attitude of said control element during inclination of the housing from horizontal.

9. A game machine controller as in claim 5, including a plurality of extension portions each selectively engageable with said lever portion, at least two of said plurality of extension portions having a different length so as to provide differential control.

10. A game machine controller as in claim 5, including a plurality of extension portions each selectively engageable with said lever portion, at least two of said plurality of extension portions having a different weight so as to provide differential control.

11. A game machine controller as in claim 5, wherein said extension portion includes a threaded shaft and a threaded washer rotatably engaging the same for being selectively displaced along the length of said threaded shaft.

12. A game machine controller as in claim 11, further comprising an annular weight seated on said washer for being selectively displaced along a length of said threaded shaft.

13. A game machine controller as in claim 12, wherein said annular weight is selectively removable and replaceable to adjust a weight of said extension portion.
